(19) United States
(12) Patent Application Publication
(10) Pub. No.: US 2007/0226783 A1
(43) Pub. Date: Sep. 27, 2007

(54) USER-ADMINISTERED SINGLE SIGN-ON WITH AUTOMATIC PASSWORD MANAGEMENT FOR WEB SERVER AUTHENTICATION

(75) Inventor: James R. Mimlitsch, Irvine, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Rabbit's Foot Security, Inc. (a California corporation), Irvine, CA (US)

(21) Appl. No.: 11/686,821

(22) Filed: Mar. 15, 2007

Related U.S. Application Data
(60) Provisional application No. 60/783,084, filed on Mar. 16, 2006.

(51) Int. Cl. H04L 9/32

(52) U.S. Cl. 726/4

(57) ABSTRACT

A secure login management system is coupled to at least one client system and coupleable to at least one target system and includes a sign-on module for connecting the user to a target system secured against unauthorized access, using at least target system authentication data expected or required by the target system, wherein the secure login management system is at a distinct network address from the user's client system and is accessible by a plurality of client systems available to the user. The secure login management system can provide access by client systems without requiring special preconfiguration of specific client systems or special configuration of target systems. The authentication data can include one or more of a username, password, fingerprint, digital sequence derived from a security device possessed by the user, and/or one-time use password. The secure login management system might perform authentication data management to automatically generate new target system authentication data.

### CROSS-REFERENCE TO RELATED APPLICATIONS

This application claims priority from co-pending U.S. Provisional Patent Application No. 60/783,084 filed Mar. 16, 2006 entitled “User-Administered Single Sign-On With Automatic Password Management for Web Server Authentication” which is hereby incorporated by reference, as if set forth in full in this document, for all purposes.

### FIELD OF THE INVENTION

The present invention relates generally to a network sign-on system and in particular to a system and method for providing a network sign-on for multiple services that is user-administered and can include automatic password management.

### BACKGROUND OF THE INVENTION

Network services that can be accessed by a client connecting to a server over an insecure network (or at least a network that is presumed to be insecure) can be secured using client authentication. With client authentication, the server does not allow a client access to a network service unless and until the client can authenticate itself as an authorized client. In one approach to authentication, the server requests or expects a user identifier and a password, the client supplies a proposed user identifier and password, the server checks the proposed user identifier and password and if it acceptable, allows the client access to the protected service. In some variations, the user identifier is implicit in the password, i.e., each distinct user has a distinct password and the client need not provide a separate user identifier to gain access.

A client is a computer, computing device, electronic system, etc. that a user uses to access a network service. The user can be a human user, an automated computer process user, or might even change between the two from time to time. A network service is some computing, communications, interface, electronic, etc. service that is provided by a server over a network. The network can come in many forms. A common network in use today is the Internet, a global network of networks used in various embodiments (intranet, extranet, open network, etc.), but other networks can be used as well. A server is a computer, computing device, electronic system, etc. that responds to requests from clients to provide a desired response, an error message or other information or data.

In a typical operation, a client sends a request over the network directed at a server. The server, upon receiving the requests, determines what the request is about and whether to service the request or reject it, and then takes the appropriate action. Authentication is a process of allowing the server to determine whether the client is being controlled by the user that the client represents it is being controlled by. A secured server includes logic to handle authentication to verify the claims of the client prior to supplying the client with the desired response to a request. The logic of the client and/or server can be in the form of special-purpose hardware, program code executed by a general-purpose processor, and/or other known implementations of logic.

Servers are secured to require authentication for a number of reasons, and the description here is not intended to limit the reasons for authentication, unless explicitly indicated. Servers might be secured because they have the potential to serve up customized or sensitive data. For example, a bank's Web server might provide access to services that read and write from the bank's databases and execute transactions, thereby allowing bank customers to read their account balances and other information and to initiate transfers and other transactions using a Web client. In such a case, it would be important, for the bank and its customers, that the Web server ensure that the Web client making requests for information or transactions is a Web client operated by a user who is authorized to make those requests. As used herein, “Web” refers to a collection of hyperlinked documents often referred to as the “World Wide Web” and/or more generally, dynamic or static documents accessible over a network using the HyperText Transport Protocol (HTTP).

A typical user might have authorization for many services. For example, a user might have Web access accounts set up for a bank, for an on-line shopping site, for an on-line bookseller, for an on-line e-mail reader, for an investment research site, for other paid services, for other customized services, and on and on.

With so many authentication instances, the user would have to remember a dozen or more different user identifiers and corresponding passwords, possibly adopting an insecure habit of use trivial passwords that are easy to remember (and susceptible to dictionary attacks), using the same user identifier and/or password at multiple sites, write passwords down, etc., forcing a tradeoff between usability and security. Additionally, users having to remember one or many passwords often avoid changing them even though security experts recommend frequently changing passwords. This situation can result in user frustration, poor perception of network security and lack of use of inadequately secured Web sites. These problems are costly for companies that can more cost effectively serve users over a network interface than face-to-face or over the phone.

FIG. 1 is a block diagram of a system 10 and process (illustrated by the numbered arrows indicating data flows) that might be used for logging a target system that is secured against unauthorized use of services provided by that target system. Of course, many of the systems described herein could be used to access target systems that are intentionally open and require no authentication to use. In such cases, authentication management would not be needed for access to those services.

System 10 is shown comprising a client system 12 coupled to a target system HTTP server 14 which is in turn coupled to a target system database server 16. Network traffic from client system 12 goes through a network 18 and if that network is publicly accessible, then the target system (comprising server 14 and server 16 and possibly other components not shown) would need to have some access controls and authentication process to limit access, if desired. In this example, HTTP server 14 is coupled to content storage 15 that stores Web pages, etc. and a user database 17 that stores authentication information for users with authorized access to the target server.

In a typical operation using system 10, client system 12 initiates a process (1) such as by sending a request for a login Web page (e.g., an HTTP request), and the target system responds with a login page (2). The user of client system 12 would then fill in form fields, such as a username and password, and return the filled-in page (3). If the authentication data was correct, the target system and client system would engage in services (4). This works well for one client system and one target system, but a typical user requires or desires access to many target systems, so more is needed.

FIG. 2 is a block diagram illustrating a common method of managing access to multiple target systems. In this approach, the user is called upon to memorize all of the authentication data for each target system. As can be apparent, this is unworkable for a large number of target systems. In addition, the user might be tempted to use the same username and password for each target system and use an easy-to-break password, both of which raise risks of security breaches.

FIG. 3 is a block diagram of another conventional method for handling authentication, using a client-side password manager. As shown there, client system 12 has installed thereon a toolbar 22 (usually implemented in program code and providing a user interface on a display) and interfaces to a password database 24 residing on client system 12. While this may free the user from having to memorize authentication data for many target systems, it limits the user to using that particular client system. For example, the user would be at a loss when using a remote client system 30 to access target services from there.

If the user has a large collection of authentication data, such as passwords, it is often tempting to keep the passwords the same for longer than recommended, because of the hassle of changing them. For maximum security in authenticating the identity of a user during an authentication process, passwords should be complex, changed frequently, different for each service the user accesses and committed to memory or otherwise secured against casual observers observing the passwords. Given the administrative burden this places on users, this ideal is almost never followed, even for users who are educated to the risks and ideal methods of mitigating those risks.

Even where a user's password is not readily available to the casual observer, a “social engineering” attack might result in breach of the user's password. With a social engineering attack, the attacker uses not just technological means to obtain passwords, but tricks to get the user to willingly divulge their password. For example, with a “phishing” attack, the attacker uses social engineering and technological means to get personal identity data or user identifiers and financial account credentials or passwords by, for example, sending the user a message pretending to be from the service provider asking the user to verify their personal information and/or passwords, or sending the user to a legitimate appearing Web page for sign-on that records passwords rather than actually providing access.

There exist some products/services for users that attempt to overcome these difficulties. For example, some programs include maintenance of a user database of usernames and passwords, where the user database is on the computer used by the user and/or on a removable memory device that the user connects to the client system the user is using. Some systems provide the user the ability to sync a portable device with their user database, but still require the user to maintain their user database. Such products are provided by Capitol Solutions, LLC of Phoenix, Ariz., USA (as Password Locker®), DataViz, Inc. of Milford, Conn., USA (as Passwords Plus®), AEware Inc. (as UKey SecurePassword), Siber Systems, Inc. of Fairfax, Va., USA (as RoboForm and Pass2Go), Deskperience (as “Web Replay”), the Password Safe Open Source Team (as “Password Safe”), KeyWallet GbR (as “Keywallet”), LastBit Corp. (as “My Password Manager”), Rayslab, Inc. (as “Advanced Password Manager”) and Aladdin Knowledge Systems Ltd. (as “Aladdin Web Sign-On”).

Some sign-on services are described in patents. U.S. Pat. No. 6,243,816 describes a method of managing passwords of users desiring access to multiple target resources in a computer enterprise environment. There, the targets of each given user are stored in a globally-accessible database. However, that is applicable to a closed system, uses manual password updating, requires specific software to be present at the client system and may limit user flexibility. U.S. Pat. No. 6,496,937 describes a password manager that generates new passwords from a base password according to an update schedule. U.S. Pat. No. 6,629,246 describes a system wherein passwords can be managed for multiple sites by using site-specific passwords at each site where a site-specific password is derived from site-information and a master password sequence. U.S. Pat. Nos. 5,684,950, 6,000,033, 6,178,511, 6,182,229, 6,826,700 also relate to password management systems.

Another prior approach to the problem requires that the targeted services be configured specially to allow for a sign-on service interface and thus the sign-on service cannot be used with targeted services that are not aware of the sign-on service. Some of these approaches require considerable user interaction and involvement and/or require users to manually manage passwords. For example, some may generate new passwords, but only upon user request and then require the user to cut and paste new password to a target server password change page, or manually type it in. Some do nothing to protect the user from phishing attacks.

If users are required to manually change their passwords and/or store them in password databases, the users can still fall victim to phishing attacks by providing the stored passwords upon demand to fraudulent servers/services. Therefore, users need better sign-on functionality.

### BRIEF SUMMARY OF THE INVENTION

In embodiments of the present invention, a secure login management system is coupled to at least one client system and coupleable to at least one target system and the secure login management system includes an authentication module for receiving authentication data relating to a user from a client system used by that user and a sign-on module for connecting the user, once authenticated to the authentication module, to a target system secured against unauthorized access, using at least target system authentication data expected or required by the target system, wherein the secure login management system is at a distinct network address from the user's client system and is accessible by a plurality of client systems available to the user. The secure login management system can provide access by client systems without requiring special preconfiguration of specific client systems or special configuration of target systems, thus allowing users access to the target system from any suitable client system and to access target systems that might not be preconfigured to accept an interface from the secure login management system.

The target system can be a Web server system or other server system. The authentication data can include one or more of a username, a password, a fingerprint, a digital sequence derived from a hardware security device possessed by the user, and/or a one-time use password.

The secure login management system might include an authentication data management module for automatically generating new target system authentication data for a user for a target system and a target system interface module for interacting with the target system to update the target system authentication data maintained for the target system, thereby allowing the secure login management system to modify what target system authentication data the target system expects or requires. In this manner, the user can have his or her passwords automatically generated, periodically updated, and this can occur for target servers not known in advance. The secure login management system might include a template module for generating login automation data usable by the target system interface module for interfacing to authentication data updating components of the target system. The target system might include web services and the authentication data updating components of the target system would then include Web pages and associated functionality that accept user updates to target system authentication data.

For purposes of summarizing the disclosure and the advantages achieved over the prior art, certain advantages of the disclosure have been described herein. Of course, it is to be understood that not necessarily all such advantages may be achieved in accordance with any particular embodiment of the disclosure. Thus, for example, those skilled in the art will recognize that the disclosure may be embodied or carried out in a manner that achieves or optimizes one advantage or group of advantages as taught herein without necessarily achieving other advantages as may be taught or suggested herein. All of these embodiments are intended to be within the scope of the disclosure herein disclosed, the disclosure not being limited to any particular preferred embodiment disclosed.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and parenthetical references are used to denote enumerated instances of like elements, and in which:

FIG. 1 is a block diagram of a conventional system and process for a client system to log in to a target system that is secured against unauthorized use of services provided by that target system.

FIG. 2 is a block diagram illustrating a common method of managing access to multiple target systems wherein the user memorizes all the usernames and passwords.

FIG. 3 is a block diagram of another conventional method for handling authentication, using a client-side password manager.

FIG. 4 is a block and flow diagram illustrating a system according to aspects of the present invention, wherein client systems use a secure login manager to handle authentication and authentication data management.

FIG. 5 is a block and flow diagram illustrating a system using a secure login manager, in more detail.

FIG. 6 is an operational flow diagram providing a functional overview for multi-factor authentication and for using a secure login manager to access target systems, such as those operating secured Web sites.

FIG. 7 is a block diagram illustrating portions of the secure login manager in greater detail.

FIG. 8 is an operational flow diagram illustrating interaction between a secure login manager and a target system in a process of automated password changes and authentication data management.

FIG. 9 is a block and flow diagram illustrating interactions in a process for login template generation.

FIG. 10 is an operational flow diagram providing a functional overview for login template generation.

FIG. 11 is a schematic of an example client system that might be used as the client system illustrated in other figures.

FIG. 12 is a schematic diagram of an example of internal components of the example client system shown in FIG. 11.

FIG. 13 is a block diagram of examples of what components might be stored in memory of the example client system shown in FIG. 11.

FIG. 14 is an illustration of a screen shot of a representative user interface display by a program for selecting a target service at a client.

FIG. 15 is a design view of a secure login manager and components related thereto.

FIG. 16 is an illustration of a screen shot of a representative user interface display by a program for use by a user in authenticating to a sign-on management service provided by a secure login manager.

FIG. 17 is an illustration of a screen shot of a representative user interface display by a program for use by a user of the sign-on management service to access authentication details for individual target services.

FIG. 18 is an illustration of a screen shot of a representative user interface display by a program for use by a user of the sign-on management service to add/modify access authentication details for target services.

FIG. 19 is an illustration of a screen shot of a representative user interface display by a program for use by a user of the sign-on management service to assign categories to the user's target services.

FIG. 20 is an illustration of a screen shot of a representative user interface display by a program for use by a user of the sign-on management service to manage categories used for categorizing the user's target services.

FIG. 21 is a specific example of a template for a system where templates take the form of an XML data structure.

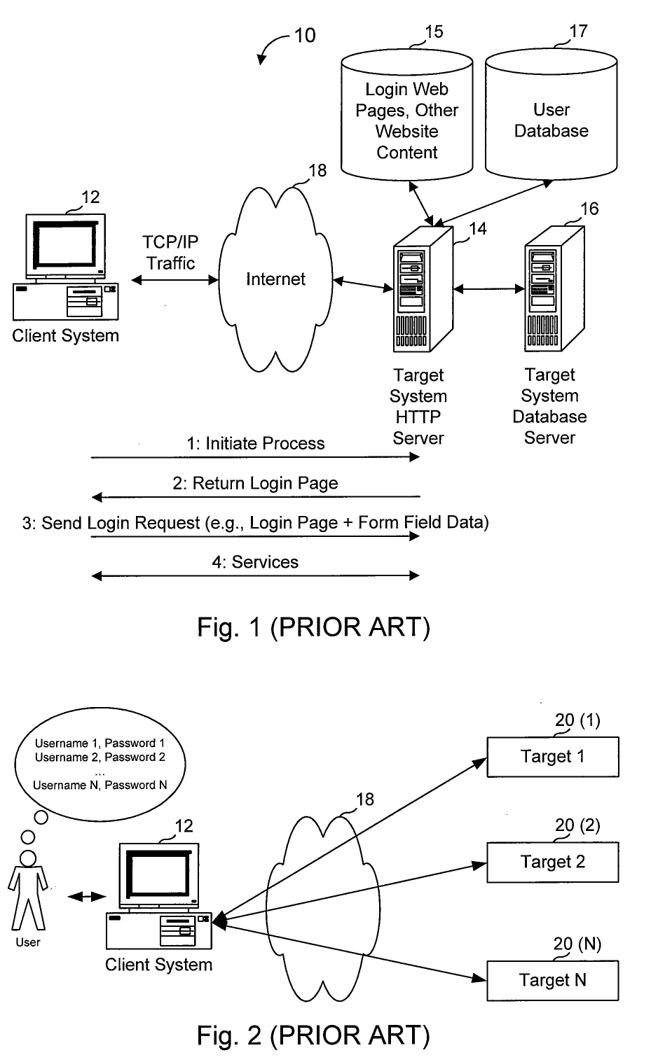

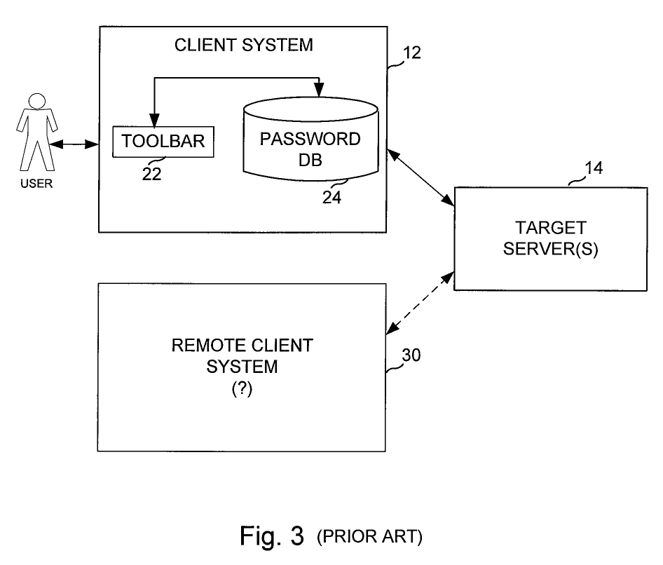

### DETAILED DESCRIPTION OF THE INVENTION

This disclosure describes embodiments of a sign-on management service and several variations. These embodiments can be implemented in a number of ways, some of which are described herein in detail and others that should be apparent to one or ordinary skill in the part upon reading this disclosure. Generally, a sign-on management service is provided to a user to manage authentication processes that the user uses to authenticate to targeted services. For example, the user might use the sign-on management service to manage details usable for accessing the user's targeted bank Web site. Some of these embodiments of a sign-on management Web site can be used by a user to manage authentication for all of the user's targeted Web sites that require authentication, as well as providing automatic password management and can do so without the user knowing their passwords used for the individual targeted Web sites. As used herein, “Web site” generally refers to a server/service that is presented to clients as a collection of dynamic or static Web pages served from one or more domain.

In the typical embodiment, the sign-on management service automatically signs the user on to the targeted Web sites in a secure manner and without requiring additional interaction by the user. Where the sign-on management service is supported by a Web server, the service can be provided to users via many different Web clients (e.g., different Web browsers, different operating systems, different computing platforms, etc.) and from many different locations.

The automatic password management feature allows the service to automatically select, manage and change passwords for the user's targeted services. Using this feature, passwords for the targeted services can be changed, can be difficult-to-crack passwords, and can be opaque to the user, thereby making social engineering attacks less successful. For example, since the user does not need to remember, or even know, their passwords, the passwords are not constrained to be short enough for a person to remember and can even be randomly generated, so that they are almost impossible to guess, not susceptible to a dictionary attack, etc. The automatic password management feature can also be set to change the passwords at variable intervals selectable by the users, so that even if the passwords were captured for use in a replay attack, they would not be good for very long.

Using the systems, methods and/or apparatus described herein, a user can more easily manage the authentication processes needed to authenticate to a plurality of independent target systems that require independently generated authentication data, in a way that promotes ease of use and security. In a typical operation, the user authenticates to a secure login management system that is preferably available to the user using a variety of client systems at a variety of locations. That secure login management system then handles authentication of that user to a target system, typically interacting with a portion of that system referred to as a target server, which controls access to the target service. The secure login management system can automatically authenticate the user and can also automatically generate and update authentication data with the target servers and can even automatically or semi-automatically determine how to perform these tasks with target systems that are not especially configured to accommodate such automatic operations.

Notably, where the authentication data, such as usemname and password, for a target system is not displayed to the user, but automatically generated and used, the user is then not susceptible to social engineering attacks and the authentication data can be more complex, such as randomly generated strong passwords. Herein, it should be understood that “random” and “randomly” include “pseudorandom” and “pseudorandomly.”

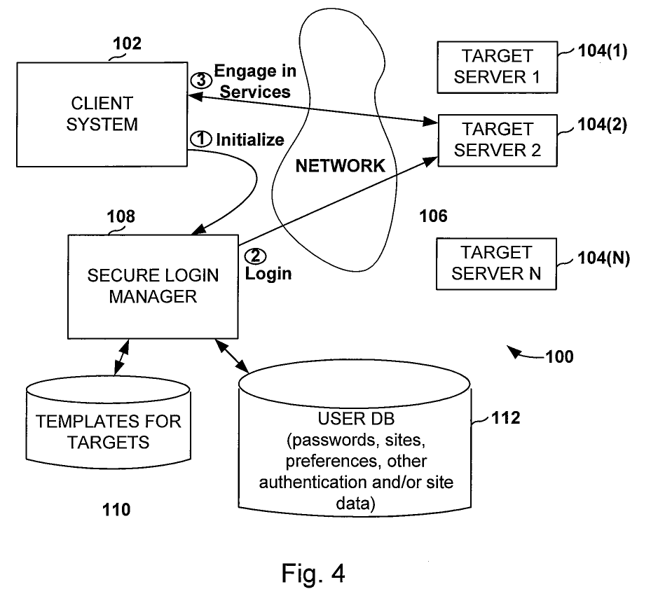

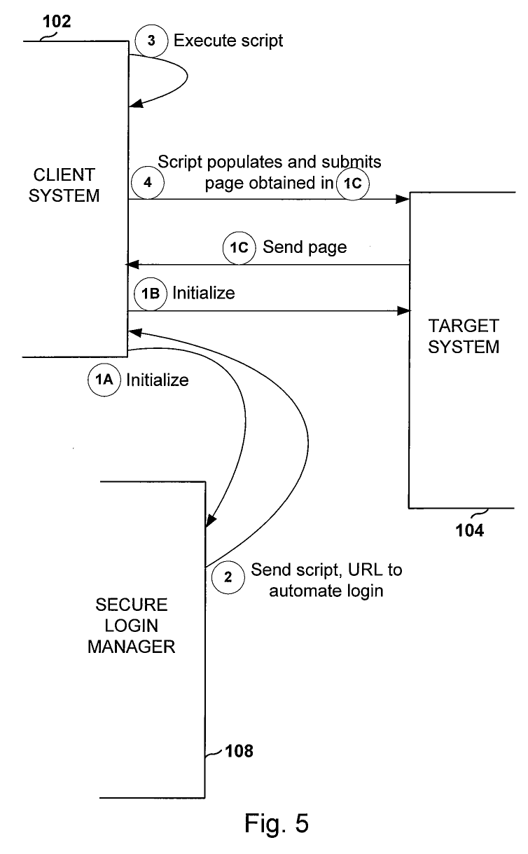

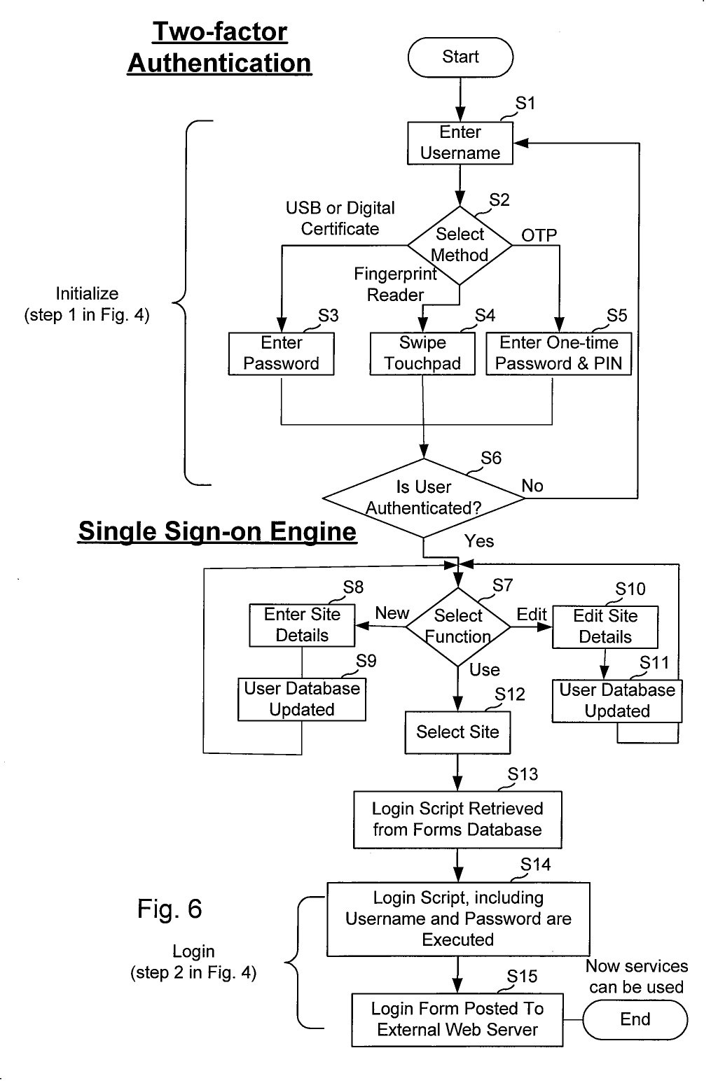

FIG. 4 is a block and flow diagram illustrating a system 100 according to aspects of the present invention, wherein client systems use a secure login manager to handle authentication and authentication data management. System 100 is shown including a client system 102 and target servers 104(1), 104(2), . . . , 104(N), wherein N is an indeterminate number in each instance used. Also included are a network 108 over which client system 102 and target servers 104 interact and a secure login manager (SLM) 108 that is also coupled to network 108. Network 108 might be the Internet, a global internetwork of networks. SLM 108 is coupled to read and write from a templates database 110 and a user database 112.

In the illustrated interaction flow, client system 102 initializes by connecting to SLM 108 and authenticating the user of client system 102 to SLM 108 (step 1). This can be initiated by the user directing a browser of client system 102 to retrieve a page having a URL pointing at SLM 108 or its servers, or it might be done by the user invoking a toolbar to connect to SLM 108. In some embodiments, a user might have access to more than one SLM and an SLM would be most likely used by many different users. Once initiated, SLM 108 would then communicate with the desired target server to authenticate the user with the target server using the authentication data stored in user database 112 for that user and that target system (2). Once authenticated, then client system 102 and the target system interact to provide services.

Most of the examples here use a Web server system at the target system, but it can be some other server system. The authentication data can include one or more of a username, a password, a fingerprint, a digital sequence derived from a hardware security device possessed by the user, and/or a one-time use password or other known types of authentication data usable with a target system to indicate to the target system that a requester of services is an authorized requester of those services. Sources of authentication can also include detected URLs or other source verification procedures, other user biometrics, tokens that are previously provided to a user (such as on a portable memory, including but not limited to a memory device or previously delivered to the user by electronic transmission). A good authentication procedure might include at least two or more sources of authentication.

In many of the examples mentioned herein, the authentication data for a user for a target system is a username and password specific to that target system (or an array of allied target systems). Other forms of authentication data might be used instead, so long as that is the authentication data required or expected by the target system and, in most cases, data usable by the target system to identify the user that is authenticating.

The authentication to the SLM can, and is often, be of a different type than the authentication to a target system. Preferably, the SLM uses some form of multi-factor authentication. For the SLM and target system authentications, multiple forms of authentication might be allowed, such as a one-time password (“OTP”) or hardware random number generator.

In some cases, the target system might have security features that prevent authentication data from being presented from a location different than that which is to use the services. In such cases, the client system can provide the information, even though it is maintained at the SLM.

FIG. 5 is a block and flow diagram illustrating a system using a secure login manager, in more detail, wherein a client system explicitly provides authentication data to a target system. As shown there, client system 102 initiates the process by authenticating to SLM 108 (step 1a) and also initiates a process with the target server (1b), such as by requesting a login page, in response to which the target server returns the login page (1c) to the client system. SLM 108 in turn sends a template (2) to client system 102 to execute (3), which results in the login page being filled in and submitted (4) to target system 104.

The sent template might be in the form of an HTTP message with placeholders for variable values, an HTML page with form fields, a list of instructions, a script that is to be executed to create an instance of the template, XML text, or similar approaches. The SLM system can handle a wide variety of template needs. For example, some target services use a single login page on the target HTTP/HTTPS server where the user is expected to fill in two form fields labeled “username” and “password”. This simple interface is easily dealt with by the SLM system, but more complex needs can also be handled. For example, where the form fields are different names and/or different in number, those can also be handled by an SLM template. (As described below, these SLM templates can be auto- or semi-auto generated from a user login sequence, when the SLM does not already have a template for some target services.) An SLM template can also handle target servers that call validator routines and can handle auto-login even if there are no explicit buttons (e.g., “submit”) for the user to click on. An SLM template might also include scripts. Some templates might have logic to handle target sites that expect to take the user's typed-in password from a visible password textbox and copy it to a hidden textbox before submitting it.

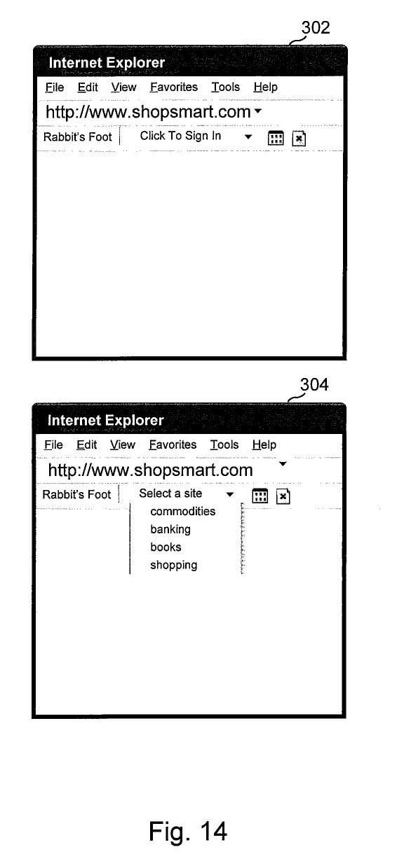

For example, the user might use the client system to direct a client browser to a URL for the SLM, and choose a third-party Web Site that is a target server that is in the SLM user database for that user, perhaps using a toolbar such as that shown in FIG. 14. The SLM can then either log in the user directly or cause the client to spawn a new browser window on the client system, then populates a page in that browser with the user's authentication information for that third-party Web Site. When the client's browser posts the authentication information to the third-party Web Site, the third-party Web Site's server can be expected to process the form and log in the user so the user can interact with that Web Site.

With the toolbar approach, a toolbar can be downloaded to the client on the fly or the client might already have the toolbar. With this approach, the user might use the client to authenticate to the toolbar, and then choose the target service of interest. Upon request and authentication, the SLM provides the toolbar code with directions (such as a template and data) for logging into the third-party Web Site. The toolbar can then contacts the third-party Web Site and pass the information required to log in to that Web Site's server(s). When the toolbar code posts the authentication information to the third-party Web Site, the third-party Web Site's server can be expected to process the form and log in the user so the user can interact with that Web Site.

FIG. 6 is an operational flow diagram providing a functional overview for multi-factor authentication and for using a secure login manager to access target systems, such as those operating secured Web sites. The steps of the flow diagram are referenced by step numbers (S1, S2, etc.), but the steps might be performed in other orders.

In this example, the authentication data used to authenticate to the SLM and to the target sites takes a specific form or forms, but other forms might be used instead. First, the user enters his or her username that would identify the user to the SLM (S1). Then the user, or the client system, selects a type of authentication data to provide (S2). With a USB device or a digital certificate, the user might enter a password (S3), or with a fingerprint reader, swipe a touchpad (S4) or enter a one-time password (OTP) (S5).

At this point, the SLM determines if the user is authenticated to the SLM (S6). If not, the process loops back to step S1. Otherwise, the process continues with the user or the SLM selecting a function (S7). Where the function is “enter new site/target system”, the target system details are entered (S8) and the user database is updated (S9). Where the function is “edit site/target system data”, the target system details are edited (S10) and the user database is updated (S11). Where the function is “use a target site/system”, a site is selected by the user (S12), a login template retrieved from the template database (which may be part of the user database or separate) (S13), the template is populated with authentication data (for example, a login form page is the template and the form fields are “username” and “password”, “SSN” and “password”, “lastname” and “security code”, etc.) for the selected target system (S14) and submitted to the target system (S15). At that point, if the target system authentication data is accepted, services can occur between the client system and the target system.

Notably, the system can be set up so that the interactions with the SLM can be done from various client systems even if those client systems are not preconfigured to interact with the SLM. In one approach, all SLM specific code executes at the SLM. In some preferred embodiments, there is some client-side code, but that can be supplied on the fly from the SLM when a user is using a client to access the SLM. An example of such code is Java™ program code and/or JavaScript™ script code.

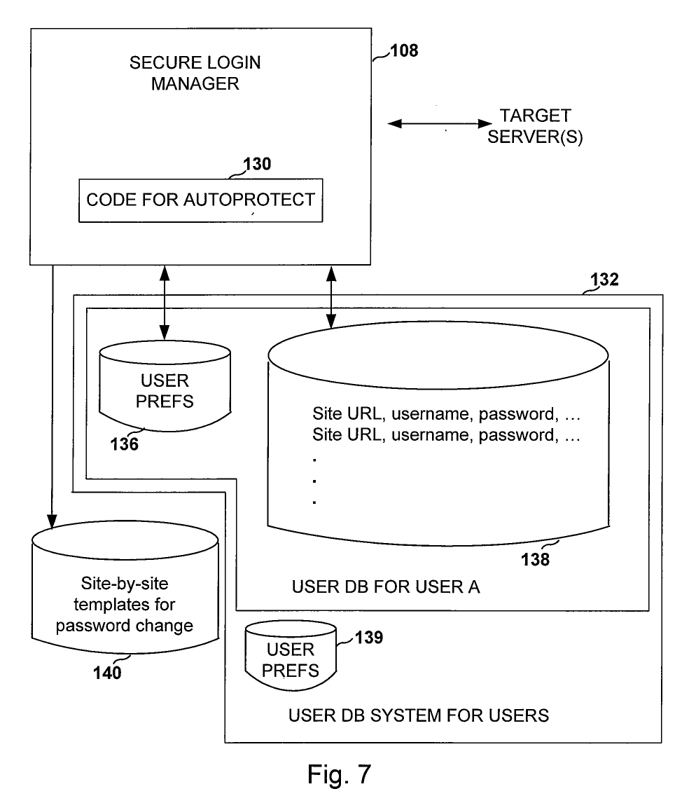

FIG. 7 is a block diagram illustrating portions of the SLM in greater detail, such as a user database system 132. User database system 132 might be organized to support multiple users and for each user maintain a user preferences database 136 and a target systems database 138. It should be understood that, where appropriate and or feasible, structured or unstructured databases could be used, such as test files with lists of preferences. In some implementations, target-specific information (such as URLs) is aggregated over users so that it is not copied over and over. With multiple users, another user might have a separate user preferences database 139 and target systems database (not shown). In one embodiment, the SLM may provide a Web interface for users and store and backup user data for target systems and other preferences, so that users can use many different client systems and do not have to move their data from client system to client system.

The SLM also interfaces to a templates database 140, which contains information used by autoprotect code 130 in automatically changing passwords and/or other authentication data.

### Automatic Password Management

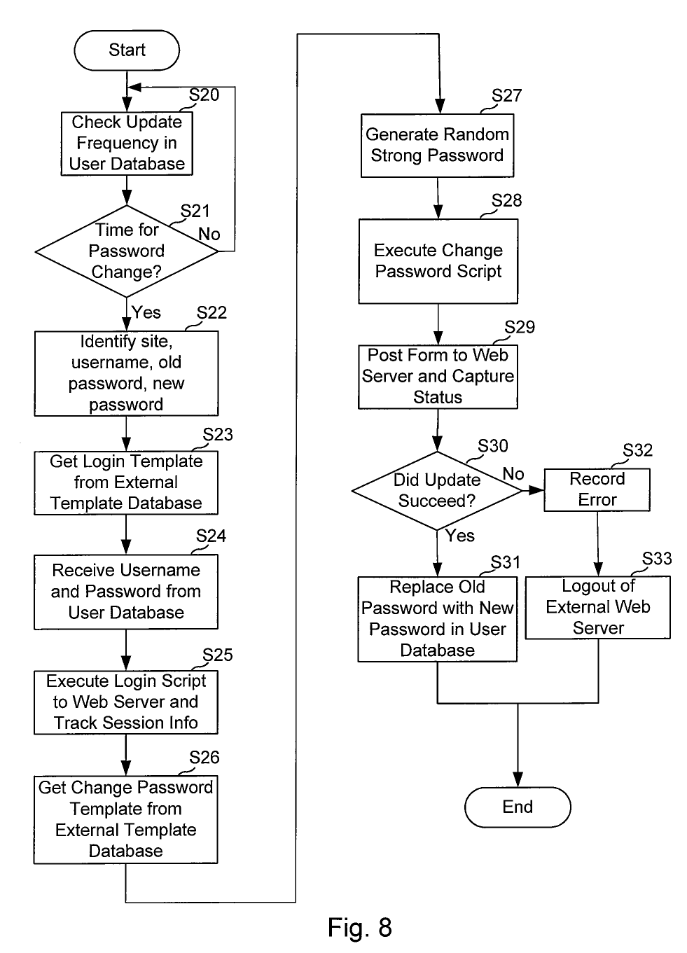

FIG. 8 is an operational flow diagram illustrating interaction between a secure login manager and a target system in a process of automated password changes and authentication data management. In that process, a user-configurable schedule is checked (S20, S21) and if it is time to change a password, the process continues at step S22, where a system/site is identified, along with the authentication data, such as username and current password, and a new password (or this is generated further into the process).

Then, a login template is obtained (S23) from the user database and executed (S24). The filled-in form is posted (S25) to the target system and tracked. At this point, the user is authenticated to the target system and a template database is consulted to obtain (S26) a password change template. A new password is generated (S27) if not already done, filled into the password change template (S28) the template is executed (S29) on the target system.

If the update succeeded (S30), the password is updated in the SLM's user database (S31), otherwise an error is recorded (S31), the user is logged out (S32) and the password data in the SLM remains unchanged.

In this manner, the SLM can automatically select, manage and change passwords or other authentication data used to authenticate to target systems, thereby removing the task of the user of manually changing the data. The changing can be done on a user configurable schedule. All of the users' data on the SLM is can be encrypted or otherwise secured. The interaction with target system and/or the SLM can be secured, such as by using SSL encryption and standard security in depth features such as firewalls, intrusion detection/prevention systems, etc.

The update frequency can either be pre-determined or may be configurable by a user or administrator. By automatically updating passwords and doing so without the user seeing the password (although in some systems, the users might view the generated passwords), security is enhanced since passwords are changed without needing the user to remember. Also, where the user does not know the password, phishing attacks and other social engineering cracking techniques are less effective.

### Template Generation

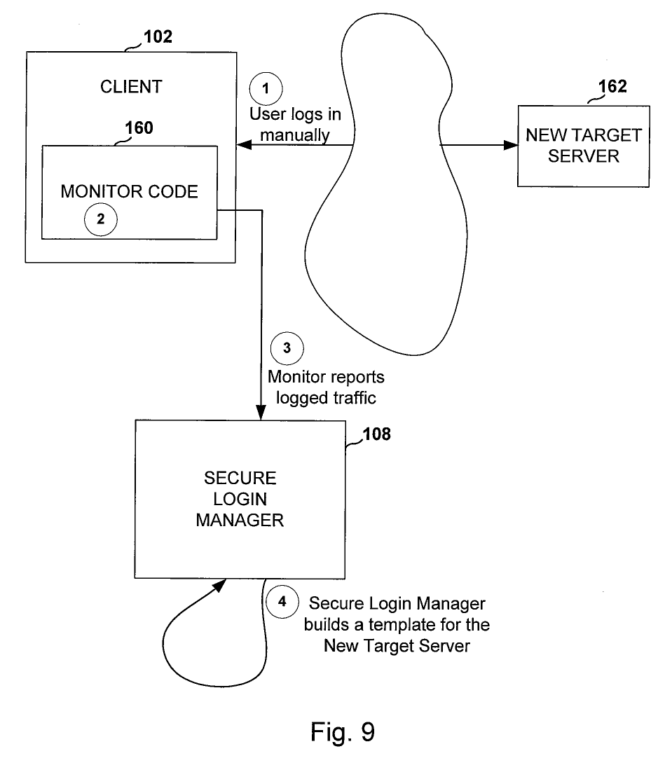

FIG. 9 is a block and flow diagram illustrating interactions in a process for login template generation. As shown there, client system 102 includes monitor code 160 for monitoring traffic of client system 102. Once client system 102 logs in normally (1) to a new target server 162 (being new in that SLM 108 does not already have an entry for that user for that target system, or for that target system for any user), monitor code 160 detects that process (2) and reports logged traffic to the SLM (3), which then builds a template for that new target server (4).

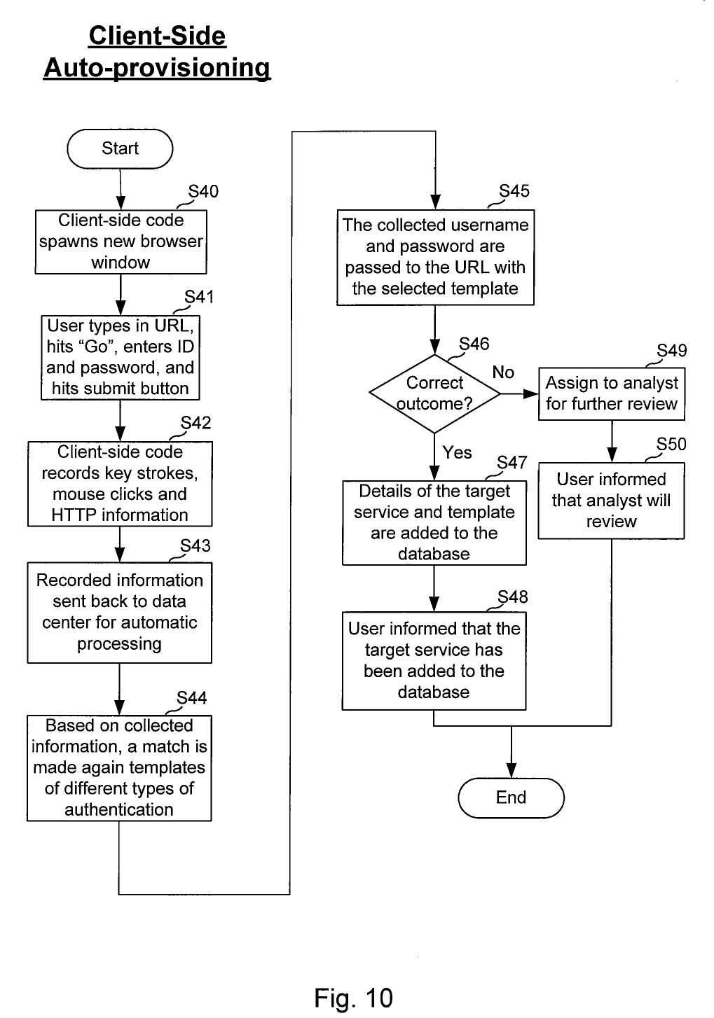

FIG. 10 is an operational flow diagram providing a functional overview for login template generation in more detail. Login template generation is useful where clients are to log in to target servers for which the secure login manager does not have a template for interfacing to the target server.

As shown in FIG. 10, login template generation might happen at a client. In an example process, a new browser window is opened at the client (S40). That browser window would provide fields for the user to provide information, such as a URL of a target server's login page, the user's username and password, etc. The user then enters that information (S41), while a client-side program or code snippet records (S42) the process (e.g., keystrokes, mouse clicks, HTTP traffic, etc.) giving notice to the user that recording is happening so that a template can be generated.

The recorded information is sent (S43) to a data center for the secure login manager and then the recorded information is compared (S44) to existing templates for different types of authentication so that a login template can be generated. At this time, or at a later time, the information might also be used to automatically fill in user database entries so that the user can use the secure login manager to login in to that new target site without having to reenter the authentication data for that user for that target site. In some implementations, it might be preferred that these steps be separate.

If the secure login manager has all the needed information, it can generate a request to the target server with the user's authentication information supplied with the generated template (S45) and the outcome checked (S46). If the user was successfully logged in, details of the target server's site and template are added (S47) to a template database and the user is informed (S48) that the template has been added and that target server is now available via the secure login manager. However if the outcome is checked and it did not result in a successful login, the result can be assigned (S49) to a human or computer analyst to debug the template so that it does work, and the user is informed of this (S50).

In the manner described above, or similar manner, the secure login manager can accumulate templates for interfacing to a wide variety of target servers even if the secure login manager has not dealt with those particular target servers before.

### Example Client System

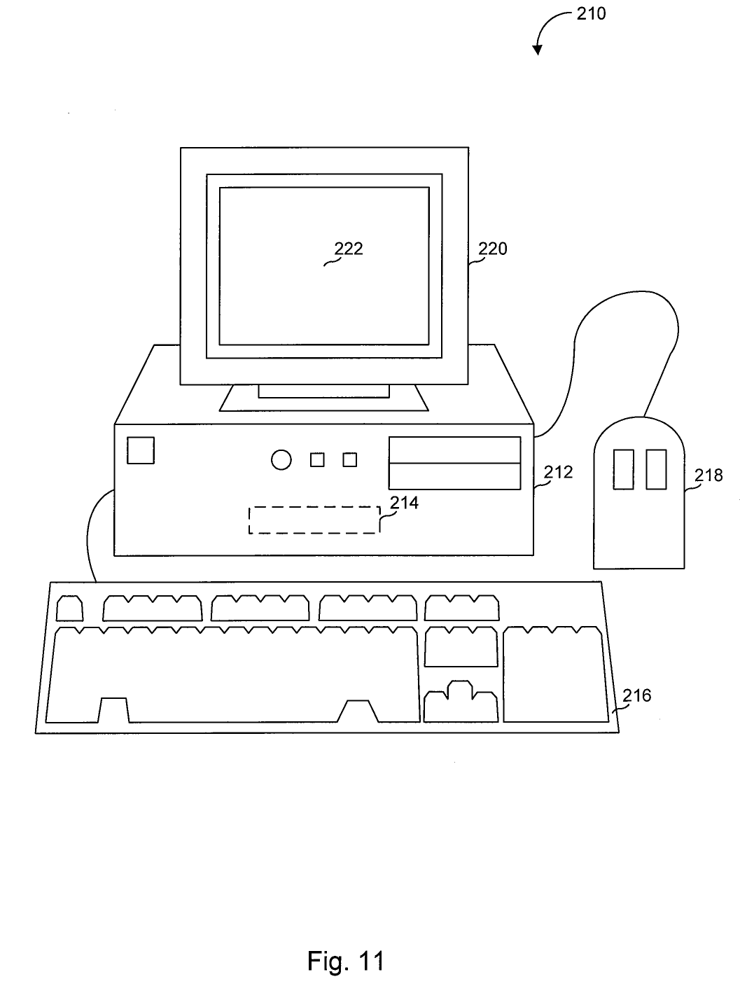

FIG. 11 is a schematic of an example client system that might be used as the client system illustrated in other figures. It should be understood that this is but one example of a client system. In this example, the client system is a desktop computer, but other client systems could include laptop computers, handheld devices, combination devices (e.g., cell phones/browsers, music players/browsers).

As shown in FIG. 11, a client system 210 comprises a main box 212 that houses CPU, memory, etc. and program storage 214 that includes program code for the various functions performed or performable by client system 210. Also shown are various interface elements, such as a keyboard 216, a mouse 218, a monitor 220 capable of displaying a user interface display 222 generated according to operation of client system 210. Not shown are other possible interfaces, such as a wired network interface, a wireless interface, etc.

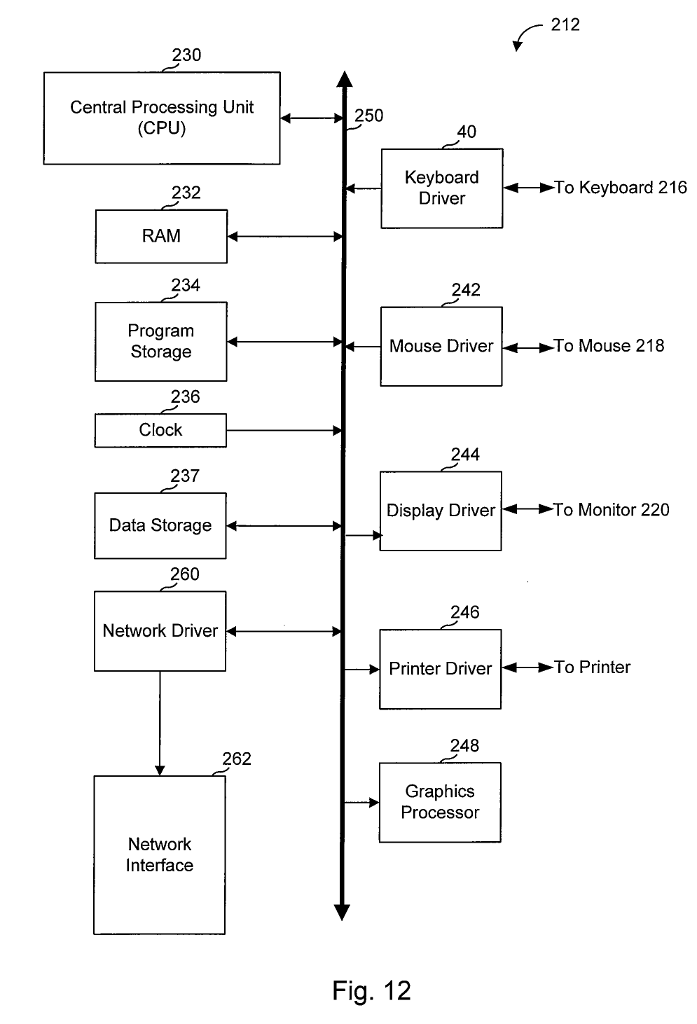

FIG. 12 is a schematic diagram of an example of internal components of main box 212 shown in FIG. 11. Again, it should be understood that this is but one example. The internal components shown include a central processing unit (CPU) 230, random access memory (RAM) 232, a clock 236, data storage 237, a network driver 238 (that interfaces to a network interface 262), a keyboard driver 240 that interfaces to keyboard 216, a mouse driver 242 that interfaces to mouse 218, a display driver 244 that interfaces to monitor 220, a printer driver 246 that interfaces to a printer (not shown), and a graphics processor 248.

Each of these components or some of these components many interface to each other via a bus 250, which might comprise one or more busses. Data storage 237 it might be a hard drive, flash memory or other structure that provides a data storage. Program storage 214 is shown separate from RAM 232 and data storage 237, but that need not be the case. In one common approach, a client system maintains program storage for operating systems, application programs and interface code on a data storage that is a hard drive, and upon initiation of the client system, it loads all or some operating system, application, and/or interface program code into RAM 232 for execution by CPU 230.

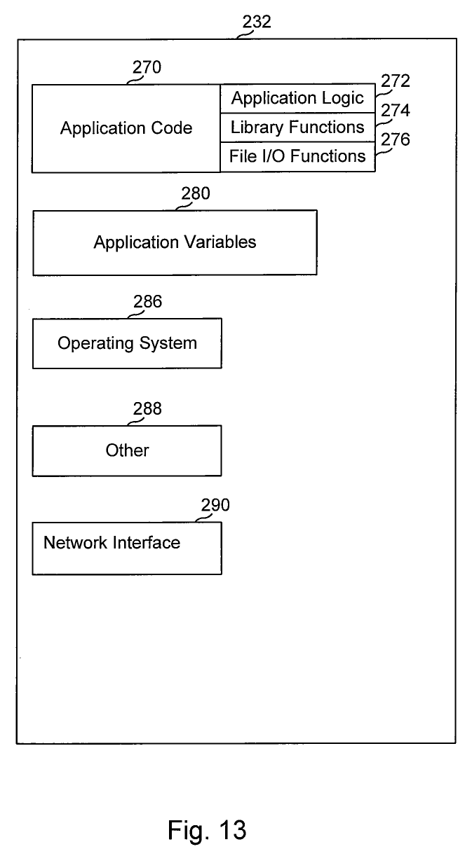

FIG. 13 is a block diagram of examples of what components might be stored in RAM 232 of the example client system 210 shown in FIG. 11 during execution of program code by client system 210. In this example, RAM 232 is shown with different sections of memory allocated to different purposes. For example, memory might be allocated application code 270, including application logic 272, library functions 274 and file I/O functions 276. Also shown is memory allocated for application variables 280, operating system code 286, other code 288 and network interface code 290. Network interface code 290, for example, might include code for handling packet transport between client device and target servers and the secure login manager, via a network.

As but one example of how these components are used, where a client system is described as performing a variety of actions, such as accepting user input and generating HTTP messages, such actions could be accomplished by program code residing in RAM 232 that is executed by CPU 230 containing instructions for obtaining input data from input devices, performing computation steps and delivering output data to output devices.

### User Interface Examples

FIG. 14 is an illustration of a screen shot of a user interface 302 for a toolbar on a client system and user interface 304 illustrates selecting a target system. In some embodiments, not even a toolbar is needed and a Web page provided by the SLM can be used by the user for selecting a target service at a client.

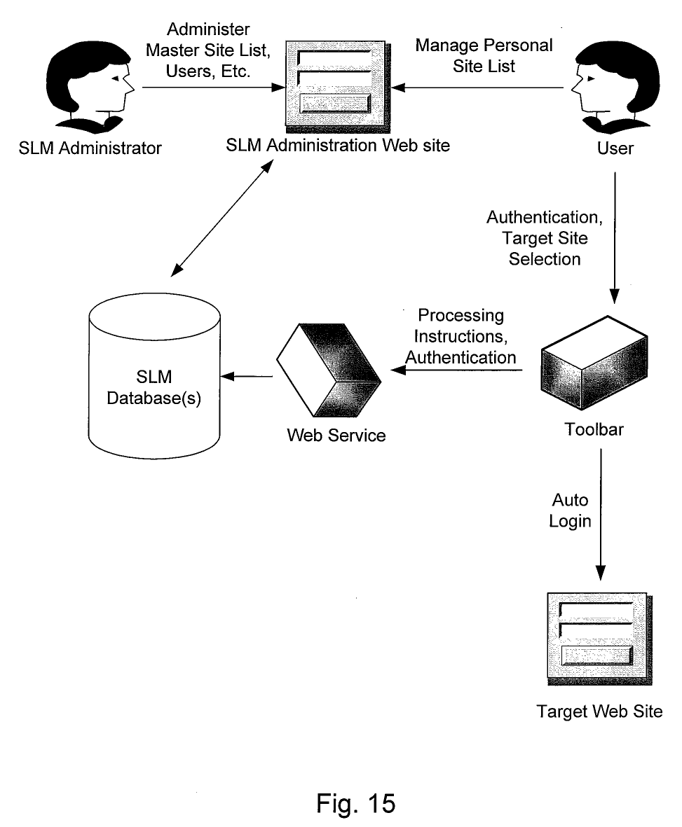

FIG. 15 is a design view of a secure login manager and components related thereto. As illustrated there, an SLM might provide an administration Web Site to allow users to review, modify and update user data as well as allowing SLM administrators to review, modify and update data. For example, an SLM administrator might coordinate the review of templates that require analyst oversight to generate working templates.

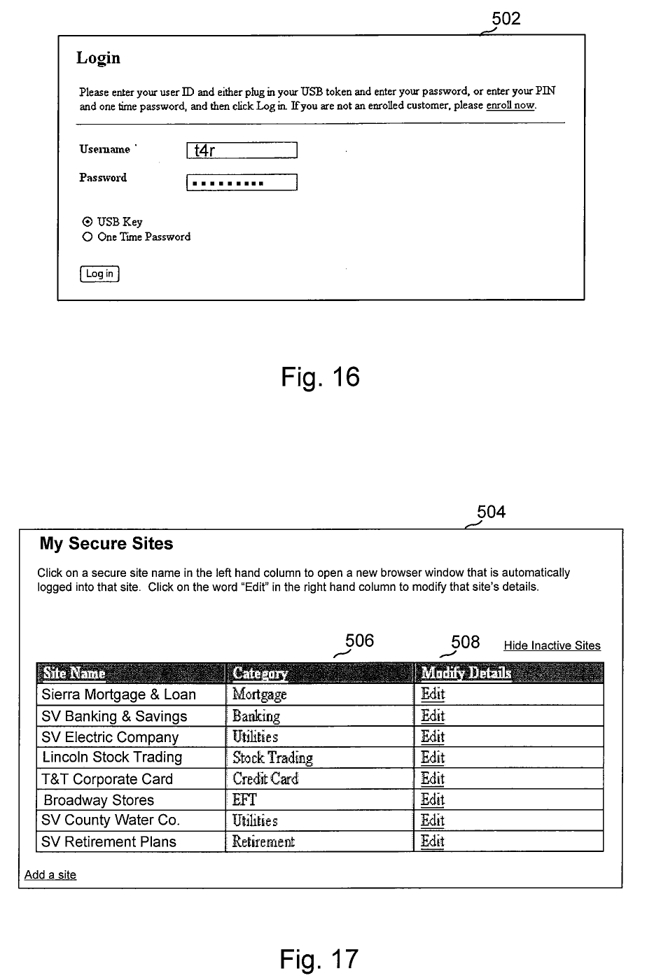

FIGS. 16-20 collectively illustrate portions of an example interface that might be displayed at a client system for interacting with a SLM. The interface might be implemented as a web-based HTTP system, such that a client system having a browser can provide the user with all needed interactions. In the example of FIG. 15, the interface is an administration Web Site.

FIG. 16 is an illustration of a screen shot of a user interface 502 for authenticating a user to a sign-on management service provided by a secure login manager. In that example, the authentication data provided is a username, password, token and/or other combination, allowing a user to specify which set of authentication data is to be provided.

FIG. 17 is an illustration of a screen shot of a user interface 504 for selecting a target service to manage. For each target service, there are shown a site name, a category 506 and a column 508 of buttons that allow for editing the data that the SLM maintains for each target service. The display might be limited to target services that have a field indicating that the service is active as to that user and might include less than all of the target systems known to the SLM for that user if, for example, they do not all fit on the display.

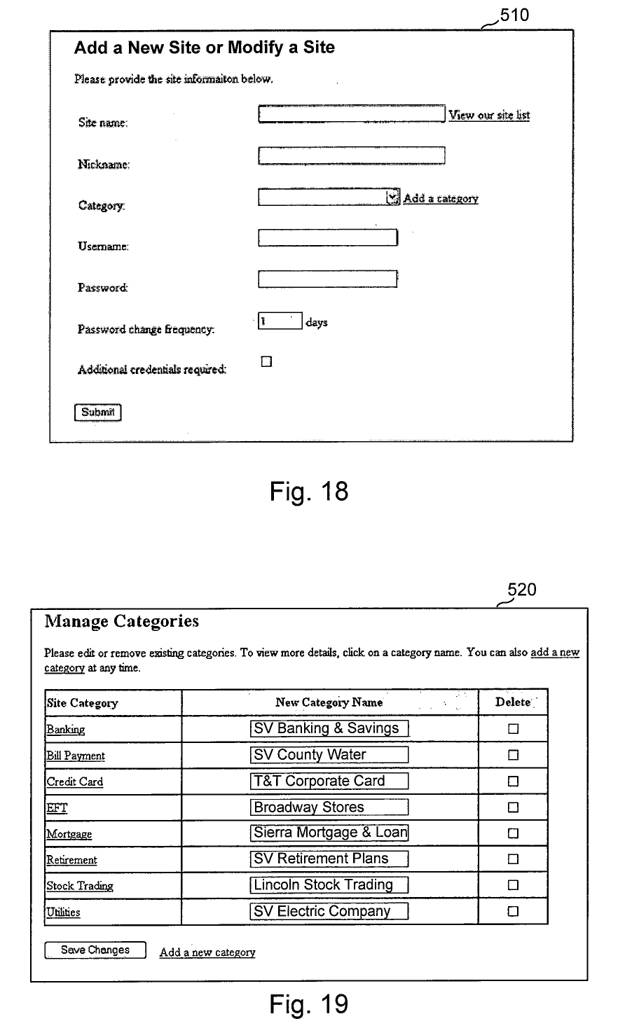

FIG. 18 is an illustration of a screen shot of a user interface 510 for modifying the authentication data for the user for the site as that data is stored by the SLM, by adding target systems for that user or modifying data for existing target systems. Other information might be stored as well, including data not normally displayed.

FIG. 19 is an illustration of a screen shot of a user interface 520 for managing categories the user can assign to the user's target services.

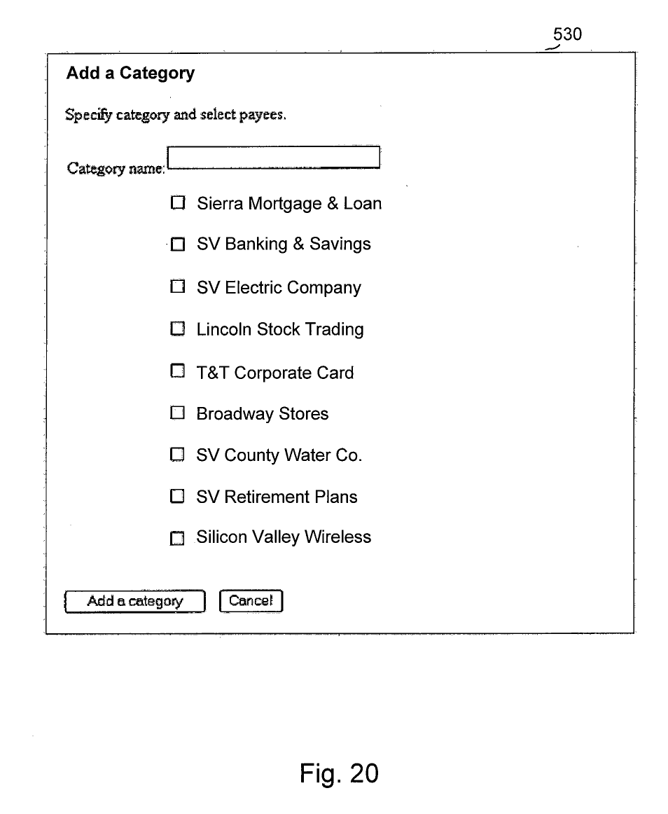

FIG. 20 is an illustration of a screen shot of a user interface 530 for managing which target systems are assigned to which categories for that user. The user might be presented with default categories for some target services when the user is first set up for those target services.

Using the above interfaces, the user can maintain the user data. The SLM can then use this data to automatically provide authentication information to the target system (directly or via the client system), thus providing increased security because the user need not know the authentication data for specific target systems. As such, the users cannot betray their interests to those seeking to commit fraud or identity theft. The user can be logged in to a target system, in a secure way with a randomly generated, strong password that the user was unaware of. Also, the automatic password management replaces the users' passwords, which in general tend to be less complex when selected by a user so that they're easy to remember, with randomly generated strong passwords. These enhanced passwords are almost impossible to guess and not susceptible to a dictionary attack.

In addition to the user interface illustrated in FIGS. 16-20, the SLM might also include an administrative interface that allows the operators or administrators of the SLM to add support for selected target systems. In one embodiment, the administrative interface is secured with encryption, two-factor authentication and other secure measures to restrict access to only the operators of the SLM.

The SLM might maintain a log of user activity, such as logging each time the user changes a preference, adds a new target server, modifies records for a target server, manually changes a password for a target site (if that is allowed), modifies the user's SLM master password, etc. The SLM might also contain a log of all user logins to the SLM and logins to target sites. A log entry might have the IP address, time, date, target server and/or other information.

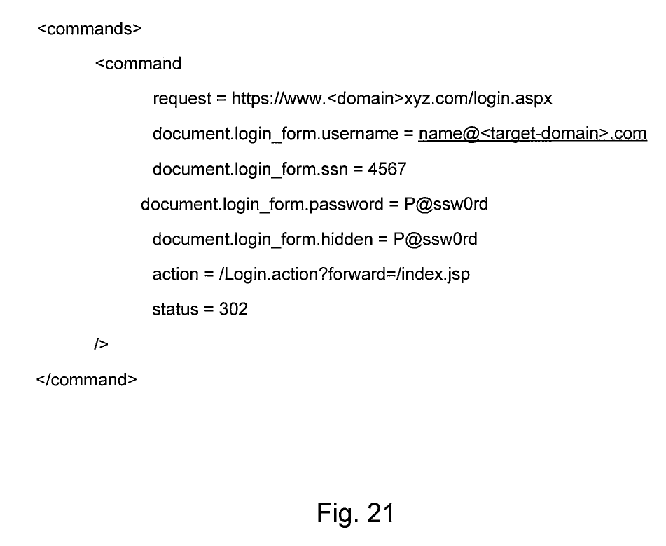

FIG. 21 is a specific example of a template for a system where templates take the form of an XML data structure.

As described above, a system and method formed in accordance with the present disclosure will provide access to multiple security-protected target systems such as publicly reachable Web servers/sites to users from many different locations. The system and method further provide password management that removes the need for users to know their respective passwords or other authentication data for specific target systems while also providing more robust security through the automatic generation of strong passwords that can be unknown to the users. As such, the users cannot betray their interests to those seeking to commit fraud or identity theft. The secure login manager can interact with the target systems to automatically sign the user or otherwise authenticate the user in a secure manner and without requiring additional interaction by the user. Additionally, the system and method can be used to automatically select, manage and change passwords on target systems for the user, thereby removing the task of the user of manually changing passwords for such systems. Also, the automatic password management replaces the users' passwords, which in general tend to be less complex when selected by a user so that they are easy to remember, with randomly generated strong passwords. These enhanced passwords are almost impossible to guess and not susceptible to a dictionary attack.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

What is claimed is:

1. A secure login management system coupled to at least one client system and coupleable to at least one target system, comprising:
an authentication module for receiving authentication data relating to a user from a client system used by that user; and
a sign-on module for connecting the user, once authenticated to the authentication module, to a target system secured against unauthorized access, using at least target system authentication data expected or required by the target system, wherein the secure login management system is at a distinct network address from the user's client system and is accessible by a plurality of client systems available to the user.

2. The secure login management system of claim 1, wherein the target system is a secured Web server system providing access to a Web site.

3. The secure login management system of claim 1, wherein the authentication data comprises a username and password.

4. The secure login management system of claim 1, wherein the authentication data comprises a fingerprint.

5. The secure login management system of claim 1, wherein the authentication data comprises a digital sequence derived from a hardware security device possessed by the user.

6. The secure login management system of claim 1, wherein the authentication data comprises a one-time use password.

7. The secure login management system of claim 1, further comprising:
an authentication data management module for automatically generating new target system authentication data for a user for a target system; and
a target system interface module for interacting with the target system to update the target system authentication data maintained for the target system, thereby allowing the secure login management system to modify what target system authentication data the target system expects or requires.

8. The secure login management system of claim 7, further comprising a template module for generating login automation data usable by the target system interface module for interfacing to authentication data updating components of the target system.

9. The secure login management system of claim 8, wherein the target system includes web services and the authentication data updating components of the target system include Web pages and associated functionality that accept user updates to target system authentication data.
